(19) United States
(12) Patent Application Publication
(10) Pub. No.: US 2026/0351983 A1
(43) Pub. Date: Nov. 5, 2026

(54) POWER TRANSMISSION DEVICE

(71) Applicant: LG INNOTEK CO., LTD., Seoul (KR)

(72) Inventor: Jeong Heum LEE, Seoul (KR)

(21) Appl. No.: 19/487,084

(22) PCT Filed: May 24, 2024
(86) PCT No.: PCT/KR2024/007062

§ 371 Date: Nov. 24, 2025

(30) Foreign Application Priority Data
May 25, 2023 (KR) 10-2023-0067955
May 22, 2024 (KR) 10-2024-0066512

(51) Int. Cl. H02J 3/38; H02J 3/0012; H02J 7/00; H02J 7/35; H02J 7/45; H02J 13/13; H02J 13/181; H02J 101/24; H02S 50/00

(52) U.S. Cl. CPC H02J 3/381; H02J 3/0012; H02J 7/35; H02J 7/45; H02J 7/875; H02J 13/1311; H02J 13/181; H02S 50/00; H02J 2101/25; H02J 2207/20

(57) ABSTRACT

A power transmission device, according to an embodiment of the present invention, comprises: a PV module connection unit; which receives power input from a PV module; a power conversion unit for converting the power input from the PV module; a battery connection unit which is connected to a battery to output power to the battery or receive power input from the battery; an inverter connection unit which, when connected to an inverter, outputs power to the inverter and is connected in parallel to the battery connection unit; and a control unit which controls the PV module by communicating with the PV module and controls the battery connection unit and the inverter connection unit to output power converted by the power conversion unit to the battery or the inverter.

### TECHNICAL FIELDS

The teachings in accordance with exemplary and non-limiting embodiments of the present invention relate generally to a power transmission device, and more particularly to a power transmission device for efficiently transmitting power from a photovoltaic module to a battery or inverter.

### BACKGROUND ARTS

Solar power generation {Photovoltaic (PV)} is an environmentally friendly energy production method that is becoming widely adopted as a replacement for conventional chemical power generation or nuclear power generation. Solar power generation systems can be either stand-alone, where the converter is connected to a battery, or grid-connected, where the system is linked to the power grid. Generally, a stand-alone system consists of photovoltaic panels, storage batteries, and power conversion equipment, while a grid-connected system is configured to connect to the commercial power supply, enabling the mutual exchange of power with the load system.

Photovoltaic modules exhibit varying maximum power points (MPP) depending on factors such as sunlight intensity and temperature. To operate solar cells at their maximum power point, optimizers or Module-Level Power Electronics (MLPE) can be employed to perform Maximum Power Point Tracking (MPPT) control at the module level.

When the output from the photovoltaic module is stored in the battery module, it undergoes two power conversions: one via the optimizer in the photovoltaic module and another via the battery DC-DC converter in the battery module, before charging the battery. At this point, the optimizer, configured in a one-to-one series arrangement with the photovoltaic module, must control the output to an appropriate DC voltage (400V class) for battery charging/discharging and for the inverter output connected to the load. This control becomes complex. Furthermore, there is the problem of the battery becoming excessively discharged during prolonged periods of inactivity in the photovoltaic power generation system, such as during user holidays or system failures.

### SUMMARY OF THE INVENTION

### Technical Subject

The technical subject to be addressed by the present invention is to provide a power transmission device that efficiently transfers power from a photovoltaic module to a battery or inverter, and a photovoltaic power generation system incorporating such a device.

### Technical Solution

To solve the aforementioned technical subject, a power transmission device according to an exemplary embodiment of the present invention may comprise: a PV module connection unit; which receives power input from a PV module; a power conversion unit for converting the power input from the PV module; a battery connection unit which is connected to a battery to output power to the battery or receive power input from the battery; an inverter connection unit which, when connected to an inverter, outputs power to the inverter and is connected in parallel to the battery connection unit; and a control unit which controls the PV module by communicating with the PV module and controls the battery connection unit and the inverter connection unit to output power converted the power conversion unit to the battery or the inverter.

Preferably, but not necessarily, the control unit may perform maximum power point tracking control on the power conversion unit to enable the PV module to output maximum power.

Preferably, but not necessarily, the power transmission device may further comprise a power line communication unit that communicates with the PV module via the power line electrically connected to the PV module.

Preferably, but not necessarily, the PV module may include an RSD unit which, upon detecting a fault in the PV module, reduces the voltage of the PV module to a value below a first value.

Preferably, but not necessarily, the PV module may include a plurality of PV modules, and the plurality of PV modules may be connected in series at the PV module connection unit.

Preferably, but not necessarily, the PV module may include a plurality of PV modules, and the plurality of PV modules may be connected in parallel at the PV module connection unit.

Preferably, but not necessarily, the PV module may include a fault detection unit for detecting any faults.

Preferably, but not necessarily, the power transmission device may further comprise: an input current sensing unit that measures the input current of the power input to the PV module connection unit; an input voltage sensing unit that measures the input voltage of the power input to the PV module connection unit; a power conversion unit output current sensing unit that measures the output current of the power output from the power conversion unit; a power conversion unit output voltage sensing unit for measuring the output voltage of the power output from the power conversion unit; and an output current sensing unit for measuring the output current of the power output to the inverter connection unit.

Preferably, but not necessarily, the power transmission device may further comprise: a first switching unit connected to or disconnected from the battery; and an initial charging unit that performs initial charging when connected to the battery.

Preferably, but not necessarily, the power transmission device may further comprise a communication unit that communicates with a battery management device that manages the battery.

Preferably, but not necessarily, the power transmission device may further comprise a second switching unit for connecting or disconnecting the inverter; and a bypass unit that forms a bypass path over the inverter connection unit when the connection to the inverter connection unit is disconnected in accordance with the operation of the first switching unit.

To address the aforementioned technical subject, a power transmission device according to another embodiment of the present invention may comprise: a PV module connection unit connected to the output of the PV module; a power line communication unit connected to the (+) power line of the PV module connection unit and performing communication with the PV module; a fault detection unit connected to the (−) power line of the PV module connection unit for detecting faults in the PV module; an input current sensing unit for measuring the current in the (+) power line of the PV module connection unit; An input voltage sensing unit measuring the voltage of the (+) power line of the PV module connection; A power conversion unit converting the power input from the PV module; A first diode connected to the (+) power line of the PV module connection, blocking current to the PV module; a battery connection unit connected to a battery, outputting power to the battery or receiving power input from the battery; an inverter connection unit connected in parallel with the battery connection unit, outputting power to the inverter when connected to an inverter; a power conversion unit output current sensing unit measuring the output current of the power output from the power conversion unit; a power conversion unit output voltage sensing unit that measures the output voltage of the power output from the power conversion unit; a first switching unit connected to the (+) power line of the battery connection unit that connects or disconnects the battery; an output current sensing unit measuring the current in the (+) power line of the inverter connection unit; a second switching unit connected to the (−) power line of the inverter connection unit for connecting or disconnecting the inverter; and a bypass unit connected to both the (+) and (−) power lines of the inverter connection unit to form a bypass path.

Preferably, but not necessarily, the power conversion unit may perform maximum power point tracking control for the PV module.

Preferably, but not necessarily, the power conversion unit may include one of a buck converter, a boost converter, and a buck-boost converter.

Preferably, but not necessarily, the power conversion unit may include a first capacitor connecting a front end (+) power line and (−) power line of the inverter connection unit.

### Advantageous Effects

According to embodiments of the present invention, the efficiency of charging the battery module from the PV module can be increased, as the PV power generation does not pass through the PV DC-DC converter and battery DC-DC converter before charging the battery. Furthermore, forming the DC-link voltage using the battery voltage facilitates system control. Operation remains possible by isolating the faulty battery during a battery failure. Battery charging is also possible during system shutdown, and balancing between batteries is facilitated.

### BRIEF DESCRIPTIONS OF DRAWINGS

FIG. 1 is a block diagram of a power transmission device according to an embodiment of the present invention.

FIG. 2 illustrates the connection relationships between the various components of the power transmission device according to an embodiment of the present invention.

FIG. 3 illustrates an implementation example of the power transmission device according to an embodiment of the present invention.

FIGS. 4 to 7 are diagrams for explaining various connection relationships of the power transmission device according to embodiments of the present invention.

### BEST MODES

Hereinafter, the attached drawings are referred to in detail to explain the preferred embodiment of the present invention.

However, the technical idea of the present invention is not limited to the some embodiments described, but can be implemented in various different forms, and within the scope of the technical idea of the present invention, one or more of the components between the embodiments can be selectively combined or replaced.

In addition, the terms used in the embodiments of the present invention (including technical and scientific terms) can be interpreted to mean what a person with ordinary skill in the art would understand, unless explicitly defined and described, and generally understood by a person with ordinary skill in the art. Generally used terms, such as those defined in dictionaries, can be interpreted in the context of the relevant technology.

Furthermore, the terms used in the embodiments of the present invention are intended to explain the embodiments and are not intended to limit the invention. In this specification, the singular form may include the plural form unless otherwise specified in the text, and when described as ‘A and (and/and) B, C, at least one (or more than one) of A, B, and C,’ it may include one or more of all combinations of A, B, and C.

In addition, terms such as 1, 2, A, B, (a), and (b) may be used to describe the components of the embodiments of the present invention. Such terms are intended only to distinguish the component from other components and are not limited by the nature, order, or sequence of the component.

And, if any component is described as being ‘connected’, ‘coupled’ or ‘attached’ to another component, that component may be directly connected, coupled or attached to that other component, as well as being ‘connected’, ‘coupled’ or ‘attached’ to another component that is between that component and that other component.

In addition, when it is stated that each component is formed or arranged ‘above or below’, the above or below includes not only the case where two components are directly in contact with each other, but also the case where one or more other components are formed or arranged between the two components. In addition, when it is expressed as ‘upper or lower’, it can include the meaning of the lower direction as well as the upper direction based on one component.

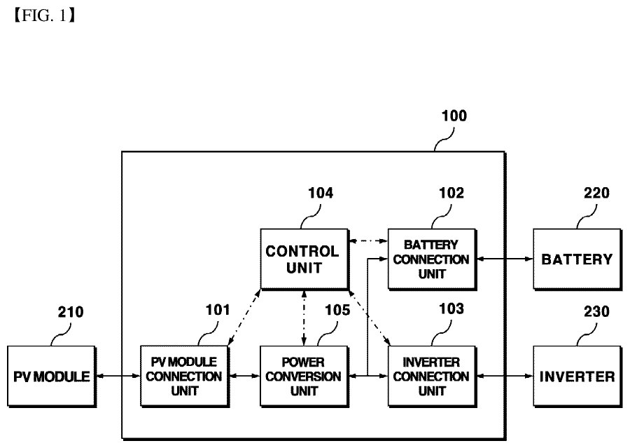

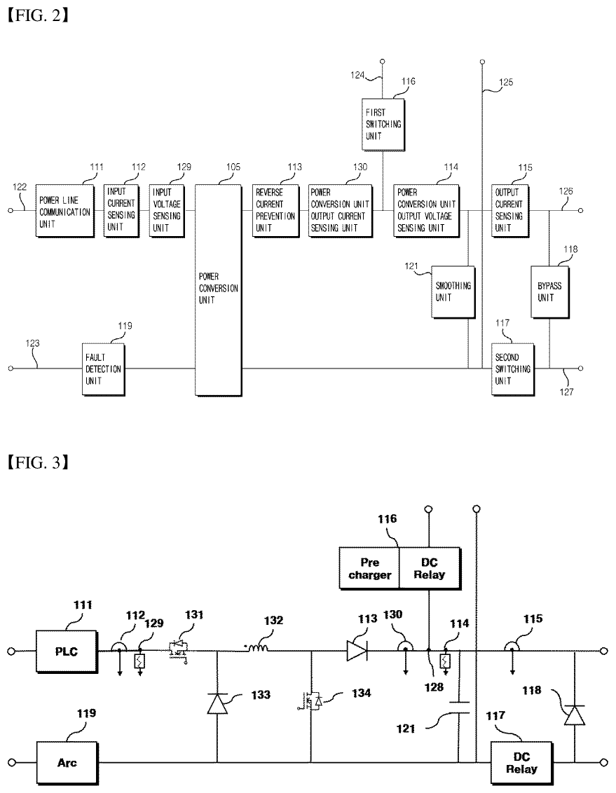

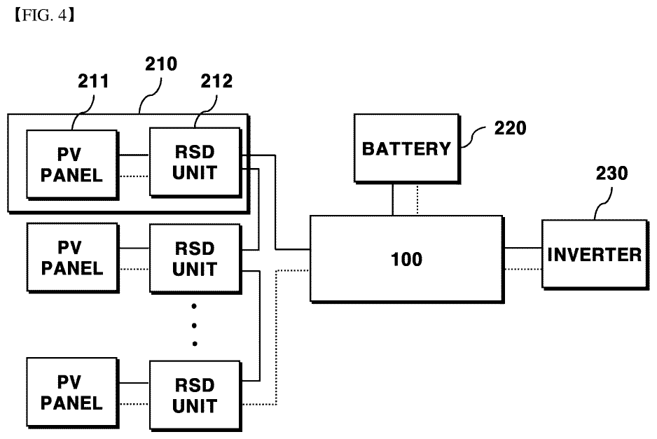

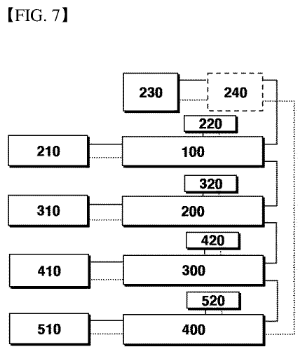

FIG. 1 is a block diagram of a power transmission device according to an embodiment of the present invention, FIG. 2 illustrates the connection relationships between the various components of the power transmission device according to an embodiment of the present invention, FIG. 3 illustrates an implementation example of the power transmission device according to an embodiment of the present invention, and FIGS. 4 to 7 are diagrams for explaining various connection relationships of the power transmission device according to embodiments of the present invention.

A power transmission device (100) according to an embodiment of the present invention may comprise: a PV module connection unit (101), a battery connection unit (102), an inverter connection unit (103), a control unit (104), and a power conversion unit (105), and may further comprise: a power line communication unit (111); an input current sensing unit (112); a reverse current blocking unit (113); a power conversion unit output voltage sensing unit (114); an output current sensing unit (115); a first switching unit (116); a second switching unit (117); a bypass unit (118); a fault detection unit (119); a smoothing unit (121); an input voltage sensing unit (129); and a power conversion unit output current sensing unit (130).

The power transmission device (100) according to an embodiment of the present invention is a device that enables efficient power transmission between a PV module (210), a battery (220), and an inverter (230). It performs a hub function and may be termed an Energy Hub. Furthermore, the power transmission device (100) according to an embodiment of the present invention may comprise a battery (220) and a battery module, or a PV module (210) and a PV module, or an inverter (230) and an inverter module. Moreover, the power transmission device (100) according to an embodiment of the present invention may comprise a PV-battery module together with a battery (220) and a PV module (210), or a PV-inverter module together with an inverter (230) and a PV module (210). Moreover, it may form a photovoltaic power generation system together with the PV module (210), the battery (220), and the inverter (230).

The power transmission device (100) according to an embodiment of the present invention may perform functions such as communication, PV module control, battery isolation, bypass, battery monitoring, detection of arcs, and RSD functionality.

Hereinafter, the power transmission device (100) according to an embodiment of the present invention shall be described in detail.

The PV module connection unit (101) is connected to the PV module (210) and receives power input from the PV module (210).

The PV module (210) generates power through photovoltaic power generation utilizing sunlight. It may include a PV panel (211) and an RSD unit (212).

The PV panel (211) may include multiple cell strings. Solar cells performing photovoltaic power generation may be represented as cell strings, where multiple cells are connected in series. A cell string may contain at least one cell, and if it contains multiple cells, these may be connected in series. A cell string may be a solar cell string comprising solar cells. A photovoltaic cell string may form a PV panel. The PV panel (211) may also be referred to as a solar panel or a photovoltaic power generation panel. A photovoltaic cell generates electricity through photovoltaics (PV), utilizing the photovoltaic effect. The photovoltaic effect occurs when light of a specific frequency or higher strikes certain metallic materials, causing electron emission. By forming a pn junction using p-type and n-type semiconductors, and utilizing the electrons generated by the photovoltaic effect to create a current, electricity is produced. Solar cells are formed using materials such as silicon and can be manufactured in wafer form. They are positioned in locations well-suited to receiving sunlight, such as open fields, building exteriors, or rooftops, to generate electricity using solar radiation. In such cases, solar cells can be integrated into the building structure itself, forming BIPV (Building-Integrated Photovoltaics).

The amount of power generated by a single photovoltaic cell is insufficient for use in a load or power system. Therefore, multiple photovoltaic cells are connected in series to form a photovoltaic cell string, thereby generating an appropriate amount of power for utilization. A solar cell string can serve as the fundamental unit for power generation. Multiple such fundamental units, cell strings, can be assembled into panels to form photovoltaic panels. Solar cells exhibit varying voltage-current characteristics depending on factors such as sunlight intensity and ambient temperature, and their maximum power point (MPP) also fluctuates. (Generated power=Voltage×Current) A PV module (210) may comprise multiple PV modules. Each PV module includes a PV panel (211) and an RSD unit (212), wherein multiple RSD units (212) are connected to the output power of each respective cell string and may be connected in series or in parallel. The RSD unit (212) can reduce the voltage of the PV panel (211) to a value below a first value when a fault in the PV panel (211) is detected. The RSD unit (212) may perform a Rapid Shut Down (RSD) function to rapidly halt the PV module (210) when a fault is detected from status information received from the PV panel (211), when a hazard such as a fire occurs, or when an RSD operation command is received from the power transmission device or externally. For RSD operation, it may include a power-dissipating resistor and a switch connecting to the resistor. By dissipating power through the resistor, the voltage of the PV module (210) can be reduced to below the first value within a short time, ensuring safety. Where the RSD function is incorporated within the power transmission device (100), the RSD unit (212) may be omitted or applied redundantly to the RSD function of the RSD unit (212), thereby enhancing safety.

The inverter connection unit (103) outputs power to the inverter (230) when connected thereto. At this time, the inverter connection unit (103) is connected in parallel with the battery connection unit (102). When connected to the inverter (230), power converted by being input from the PV module (210) can be output to the inverter (230) via the inverter (230) or a DC-DC converter (240) connected to the inverter (230).

The inverter (230) can supply the power output from the inverter connection unit (103) to a load or the grid. The inverter (230) can receive DC power output from the inverter connection unit (103), convert it to AC power, and supply power to a load or the grid. It can supply AC power to loads requiring AC power and transfer surplus power to the grid, i.e., the power system. Alternatively, it can receive AC power from the grid, convert it to DC power, and output it to the power transmission device. Here, the inverter (230) may include a DC-AC inverter. The inverter (230) may be connected to a separate power generation device, such as a diesel generator, capable of generating and supplying power when the power supplied to the load is insufficient. It may also be connected to a circuit breaker capable of disconnecting the connection to the grid, and an energy meter for measuring power received from or supplied to the grid. When the connection to the grid is disconnected, the entire system, excluding the grid, can switch to independent operation.

The battery connection unit (102) is connected to the battery (220) and outputs power to said battery (220) or receives power input from said battery (220). Power input from the PV module (210) via the PV module connection unit (101) is transmitted to the inverter (230) via the inverter connection unit (103), and the battery (220) can be charged or discharged via the battery connection unit (102). The battery (220) may include a battery management system (BMS) for managing the battery state.

The power conversion unit (105) may convert the power input from the PV module (210) into power suitable for the inverter (230) or the battery (220) when outputting it to the inverter (230) or the battery (220). It can convert the voltage of the power input from the PV module (210) to a voltage suitable for output to the inverter (230) or for charging the battery (220). At this time, the power conversion unit (105) may include one of a buck converter, a boost converter, and a buck-boost converter, depending on the magnitude of the voltage of the PV module (210). The PV module (210) may comprise a plurality of PV modules, wherein the magnitude of the input voltage may vary depending on the connection relationship between the plurality of PV modules. If the voltage input from the PV module (210) is smaller than the voltage transmitted to the inverter (230) or battery (220), a step-up is required; the power conversion unit (105) may therefore include a boost-type power conversion unit. Where the voltage input from the PV module (210) is greater than the voltage transmitted to the inverter (230) or battery (220), step-down conversion is required and the power conversion unit (105) may thus include a buck-type power conversion unit. Where the voltage input from the PV module (210) encompasses a range that is either smaller or larger than the magnitude of the voltage transmitted to the inverter (230) or battery (220), boosting or buck conversion is required and the power conversion unit (105) may thus include a buck-boost type power conversion unit.

The power conversion unit (105) may perform maximum power point tracking control to enable the PV module to output maximum power. The power conversion unit (105) may perform maximum power point tracking control to ensure the power output from the PV module (210) to achieve maximum power. That is, it can optimize the output power of the cell string to ensure the photovoltaic cells of the PV module (210) to operate at the maximum power point (MPP), which is the operating point where power is maximized under each condition. This is termed Maximum Power Point Tracking (MPPT), and utilizing MPPT can enhance the efficiency of photovoltaic power generation. In photovoltaic operation, depending on the characteristics of the relationship between current and voltage, and between voltage and power, the maximum power may occur not at the maximum voltage, but at a voltage around 80% of the maximum voltage. As this maximum power point continuously shifts depending on the magnitude of the voltage and current generated by the PV panel, the point capable of producing the maximum power must be continuously sought. That is, to track maximum power rather than maximum voltage, the magnitude of voltage and current may be varied to achieve maximum power. Specifically, voltage can be reduced and current increased, or voltage increased and current decreased, in the direction that maximizes power.

The power conversion unit (105) performs maximum power point tracking control, meaning that optimizers may not be applied to the PV module (210). That is, the power conversion unit (105) can perform the role of an optimizer that performs maximum power point tracking control.

The power conversion unit (105) can control the power used to charge the battery (220). At this time, depending on the state of the battery (220), the output power can be limited. This enhances the stability of the battery (220).

The control unit (104) controls the PV module (210) via communication with it, and controls the power conversion unit (105), the battery connection unit (102), and the inverter connection unit (103) by converting the power input from the PV module (210) to allow outputting it to the battery (220) or the inverter (230).

The control unit (104) measures input current, input voltage, power conversion unit output current, power conversion unit output voltage, output current to the inverter, etc., and receives data containing status information from the PV module (210), battery (220), inverter (230), external controller, load, etc., to enable conversion of the power input from the PV module (210) and output to the inverter (230) or battery (220), thereby controlling each configuration.

The control unit (104) may include one or more processors and may further include memory, and it goes without saying that the functions of the control unit (104) or other components may be implemented in software or hardware.

The power transmission device (100) according to an embodiment of the present invention may comprise a power line communication unit (111), an input current sensing unit (112), an input voltage sensing unit (129), a power conversion unit output current sensing unit (130), a power conversion unit output voltage sensing unit (114), a reverse current blocking unit (113), an output current sensing unit (115), a first switching unit (116), a second switching unit (117), a bypass unit (118), a fault detection unit (119), and a smoothing unit (121). Each component may be configured as shown in FIG. 2 as an embodiment.

The power line communication unit (111) may communicate with the PV module (210) via a power line electrically connected to the PV module (210). The PV module connection unit (101) may include a (+) power line (122) and a (−) power line (123), and the power line communication unit (111) may be connected to the (+) power line (122) of the PV module connection unit (101) to communicate with the PV module (210). At this time, the power line communication unit (111) may perform PLC (Power Line Communication), which communicates using the power line. Alternatively, it may communicate with the PV module (210) via other wired or wireless communication methods. The control unit (104) may control the power line communication unit (111) to communicate with the PV module (210) via PLC communication, thereby receiving information from the PV module (210) or controlling the power of the PV module (210). At this time, the power line communication unit (111) can communicate with the RSD unit (212) of the PV module (210). The control unit (104) can transmit a control signal to the RSD unit (212) via the power line communication unit (111), thereby operating the RSD unit (212). It can be controlled by transmitting a signal to operate the RSD unit (212). If the PV module (210) lacks an RSD unit (212), the power line communication unit (111) may not be included.

The PV module (210) may include a plurality of PV modules, and the plurality of PV modules may be connected in series to said PV module connection unit. The plurality of PV modules (210) may be connected in series, as shown in FIG. 4. Furthermore, the plurality of PV modules (210) may be connected in parallel to the PV module connection unit, as shown in FIG. 6.

When charging the battery (220) by receiving power from the plurality of PV modules (210), when the battery voltage is low, a single PV module can sufficiently charge the battery (220), and thus the plurality of PV modules (210) can be connected in parallel. As multiple PV modules (210) are connected in parallel, the battery (220) can still be sufficiently charged even if some of the PV modules (210) malfunction. When the battery voltage is high, it may be difficult to charge the battery using the voltage from a single PV module (210). In such cases, connecting PV modules in series can increase the magnitude of the voltage input to the PV module connection unit (101). That is, depending on the applied battery voltage, multiple PV modules may be connected either in parallel or in series.

When multiple PV modules are connected in series to the PV module connection unit, the voltage input to the PV modules may be high, and consequently, the power conversion unit (105) may be configured as a buck type or a buck-boost type. It may also be configured as a boost type. When multiple PV modules are connected in series to the PV module connection unit, the voltage input to the PV modules may be low, and the power conversion unit (105) may be formed as a boost type or a buck-boost type. Alternatively, it may be formed as a buck type.

The fault detection unit (119) can detect faults in the PV module (210). The fault detection unit (119) can detect phenomena such as arcs that may affect the PV module (210). Here, an arc is a gas insulation breakdown phenomenon that generates current through a non-conductive medium such as air. When an arc occurs, significant heat is generated, posing risks such as fire. The fault detection unit (119) may include an arc sensor, enabling detection of arc generation. The fault detection unit (119) may be connected to the (−) power line (123) of the PV module connection unit.

To monitor power input and output, an input current sensing unit (112), an input voltage sensing unit (129), a power conversion unit output current sensing unit (130), a power conversion unit output voltage sensing unit (114), and an output current sensing unit (115) may be included.

The input current sensing unit (112) can measure the input current of the power input to the PV module connection unit. The input current sensing unit (112) is connected to the (+) power line (122) of the PV module connection unit, enabling measurement of the input current. The input current sensing unit (112) may be configured as a current sensor, as shown in FIG. 3.

The input voltage sensing unit (129) may measure the input voltage of the power input to the PV module connection unit. The input voltage sensing unit (129) is connected to the (+) power line (122) of the PV module connection unit, enabling measurement of the input current. The input voltage sensing unit (129) may be configured as a voltage sensor, as shown in FIG. 3.

The input current sensing unit (112) and input voltage sensing unit (129) may be utilized to perform maximum power point tracking control for the PV module (210). Currently, by measuring the input current and input voltage, control may be exercised to ensure maximum power is output from the PV module (210).

The power conversion unit output voltage sensing unit (114) and the power conversion unit output current sensing unit (130) can calculate the power output from the power conversion unit (105). This enables the generation output of the PV module (210) to be calculated. The power conversion unit output voltage sensing unit (114) may include a voltage sensor, as shown in FIG. 3, and the power conversion unit output current sensing unit (130) may include a current sensor, as shown in FIG. 3. The control unit (104) can calculate the power generation of the PV module (210) using the current and voltage measured by the power conversion unit output voltage sensing unit (114) and the power conversion unit output current sensing unit (130).

A reverse current blocking unit (113) may be included on the output side of the power conversion unit (105). The reverse current blocking unit (113) can prevent current from being applied from the battery (220) or inverter (230) to the power conversion unit (105) or PV module (210). This enhances the safety of the PV module (210). The reverse current blocking unit (113) may include a first diode, as shown in FIG. 3. Utilizing the characteristics of the diode, it can allow current to flow from the PV module connection unit (101) through the power conversion unit (105) to the battery (220) or inverter (230), while blocking reverse current flowing in the opposite direction.

A smoothing unit (121) may be disposed between the power conversion unit output voltage sensing unit (114) and output current sensing unit (115). The smoothing unit (121) may serve to stabilize the power input from the PV module (210). The power generation of the PV module (210) is affected by the external environment and may fail to supply stable power to the inverter (230) or load due to the occurrence of noise, etc. To eliminate such unstable signals or noise, etc., a smoothing unit (121) may be connected. The smoothing unit (121) may include a first capacitor, which is a smoothing capacitor, as shown in FIG. 3.

The output current sensing unit (115) can measure the output current of the power supplied to the inverter connection unit (103). Even if the output current sensing unit (115) is connected only to the positive power line (126) of the inverter connection unit (103) among the battery connection unit (102) and the inverter connection unit (103) connected in parallel, the input current measured by the input current sensing unit (112) and the output current measured by the output current sensing unit (115) can be used to calculate the total current flowing through the power line (126). Even if the output current sensing unit is connected only to the (+) power line (126) of the inverter connection unit (103), both the output current to the inverter and the output current to the battery can be calculated using the input current measured by the input current sensing unit (112) and the output current measured by the output sensing unit (115). The control unit (104) can calculate and monitor the power output to the inverter (230) and the power output to the battery (220). The output current sensing unit (115) may be configured as a current sensor, as shown in FIG. 3.

The first switching unit (116) can connect to or disconnect from the battery (220). A switching element capable of connecting or disconnecting the battery (220) may be connected to the battery connection unit (102). The first switching unit (116) may comprise a relay element, a DC relay, a power semiconductor device, etc. The first switching unit (116) may be connected to the (+) power line (124) of the battery connection unit.

The first switching unit (116) may include a pre-charger to prevent inrush current and the like when connecting the battery (220). Prior to connecting the battery (220), the voltage at the battery connection unit (102) is formed via initial charging to correspond to the battery (220)'s voltage. Subsequently connecting the battery (220) enhances stability.

Furthermore, The first switching unit (116) may include a communication unit that communicates with the battery management system (BMS) managing the battery (220). The communication unit receives status information, such as the charge/discharge amount of the battery (220), from the battery management device. The control unit (104) can then control the first switching unit (116) or the initial charging unit using the battery's status information. In this case, the communication unit can communicate with the battery management device via wired or wireless communication, such as CAN communication or RS-485.

The second switching unit (117) can connect or disconnect the inverter (230). A switching element may be connected to the inverter connection unit (103) to connect the inverter (230) or to disconnect the PV module (210) and battery (220) from the inverter (230). In the event of a fault occurring in the power transmission device according to an embodiment of the present invention, or if power generation from the PV module (210) ceases due to RSD function operation, or if a fault occurs in the battery, the second switching unit (117) may operate to disconnect the PV module (210) and battery (220) from the inverter (230). The second switching unit (117) may comprise a relay element, a DC relay, or power semiconductor devices. The second switching unit (117) may be connected to the (−) power line (127) of the inverter connection unit.

The bypass unit (118) can form a bypass path on the inverter connection unit (103) when the connection with the inverter connection unit (103) is disconnected in accordance with the operation of the second switching unit. When the second switching unit (117) operates to disconnect the PV module (210) and battery (220) from the inverter (230), a bypass path can be formed to maintain power supply to the inverter (230) via other devices. The bypass unit (118) may comprise a bypass diode connected as shown in FIG. 3.

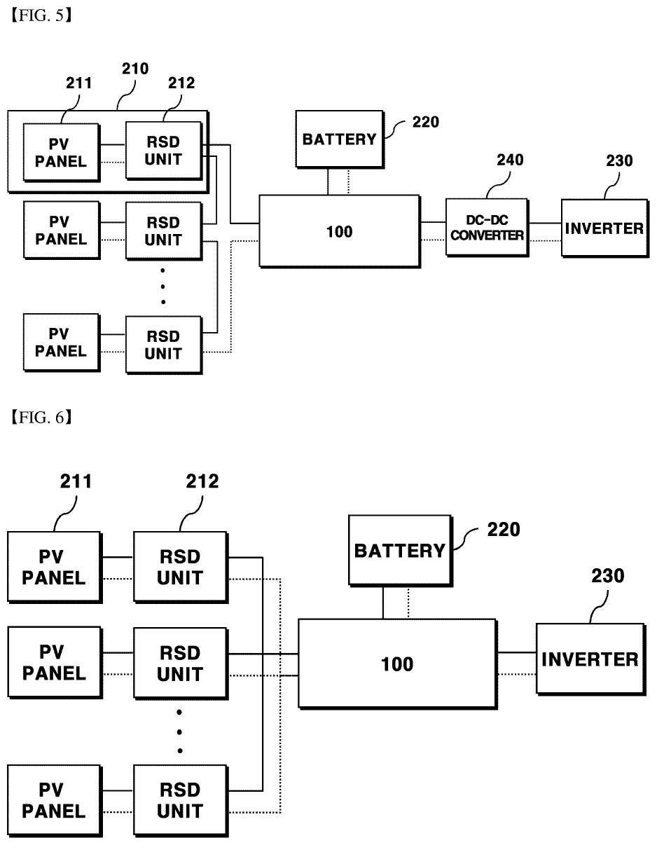

Power output to the inverter connection unit (103) may be applied directly to the inverter (230) or, as shown in FIG. 5, applied to the inverter (230) via a DC-DC converter (240). If the magnitude of the voltage of the power output to the inverter connection unit (103) corresponds to the voltage of the inverter (230), the DC-DC converter (240) may be omitted. The voltage output to the inverter connection unit (103) can be formed through voltage control based on the charging and discharging of the battery (220). This allows the DC-DC converter to be eliminated. However, if the series battery is insufficient, a DC-DC converter (240) may be required to form the voltage needed for the inverter. Furthermore, should a battery become disconnected due to a battery module failure, the battery voltage becomes unavailable. Consequently, a DC-DC converter (240) may be required to convert the PV module to a form suitable for the inverter module. Additionally, if the charging power between battery modules is not identical, a DC-DC converter (240) may be necessary to maximize battery utilization.

The power transmission device according to another embodiment of the present invention may comprise: a PV module connection unit connected to the output of the PV module; a power line communication unit connected to the (+) power line of the PV module connection unit and performing communication with the PV module; a fault detection unit connected to the (−) power line of the PV module connection unit and detecting a fault in the PV module; an input current sensing unit measuring the current in the (+) power line of the PV module connection unit; an input voltage sensing unit measuring the voltage in the (+) power line of the PV module connection unit; a power conversion unit converting the power input from the PV module; a first diode connected to the (+) power line of the PV module connection unit to block current to the PV module, a battery connection unit connected to a battery to output power to the battery or receive power from the battery; an inverter connection unit connected in parallel with the battery connection unit to output power to an inverter when connected to an inverter; a power conversion unit output current sensing unit measuring the output current of the power output from the power conversion unit; a power conversion unit output voltage sensing unit measuring the output voltage of the power output from the power conversion unit; a first switching unit connected to the (+) power line of the battery connection unit for connecting or disconnecting the battery; an output current sensing unit measuring the current in the (+) power line of the inverter connection unit; a second switching unit connected to the (−) power line of the inverter connection unit for connecting or disconnecting the inverter; and a bypass unit connected to both the (+) and (−) power lines of the inverter connection unit to form a bypass path. The power conversion unit may perform maximum power point tracking control for the PV module and may include one of a buck converter, a boost converter, or a buck-boost converter. The power conversion unit may include a first capacitor connecting the (+) power line and the (−) power line at the front end of the inverter connection unit. Detailed descriptions of each configuration correspond to the detailed descriptions of each configuration in FIGS. 1 to 6 and redundant descriptions are omitted.

The power transmission device (100) according to another embodiment of the present invention may be connected to other power transmission devices (200, 300, 400) to supply power to an inverter (230). In this case, the inverter connection unit (103) may be connected in series with the inverter connection units of the other power transmission devices (200, 300, 400). Through this, the voltages output via each PV module (210, 310, 410, 510) and battery (220, 320, 420, 520) can be connected in series to form the required voltage, thereby potentially eliminating the need for a DC-DC converter (240). Supplying power to the inverter (230) without passing through the DC-DC converter (240) enhances energy efficiency. Furthermore, when utilizing multiple power transmission devices, the system includes a bypass unit (118) that can bypass a specific battery, for instance, in the event of a fault. This allows power to be supplied to the inverter (230) using other batteries. Through this configuration and interconnection, the efficiency of power transmission from the PV module (210) to the battery (220), from the PV module (210) to the grid via the inverter (230), and from the battery (220) to the grid via the inverter (230) can be enhanced.

Furthermore, as the battery forms its own voltage, inverter link voltage control is unnecessary, and batteries may be stacked in series without applying a DC-DC converter. In the event of a battery failure, the affected battery can be disconnected, allowing continued operation. Even if the system remains inactive for extended periods due to user holidays or system malfunctions, the battery can be charged using power from the PV module (210), thereby preventing over discharge. Furthermore, battery balancing control is achievable through PV power generation control linked to the battery, enabling individual charging control. Additionally, operation as an AC-coupled product is possible using only the battery (220) without PV modules (210). It is possible to add the PV module (210) while operating as an AC-coupled product, or to add the battery (220) while operating as a PV-inverter product without the battery (220). Bypass operation is also possible in the event of a system fault within a battery module configuration.

Furthermore, in case of providing stable high voltage for buildings or industrial applications, multiple battery module units connected in series can be connected in parallel with other battery module units. This enhances the scalability of the series-parallel design.

Furthermore, the power transmission device according to an embodiment of the present invention may comprise a PV module connection unit that receives power input from PV modules, a battery connection unit connected to a battery that outputs power to the battery or receives power input from the battery, an inverter that outputs power, and an inverter connection unit connected in parallel with said PV module connection unit. The PV module connection unit and the inverter connection unit are connected in parallel, and the battery connection unit is connected to the battery, enabling power to be supplied to the inverter (230) using power from either the PV module or the battery. In this case, the battery may be connected in series, thereby eliminating the need for a DC-DC converter (240).

A person skilled in the art relating to the present embodiments will understand that the disclosed methods may be implemented in modified forms without departing from the essential characteristics of the above-described embodiments. Therefore, the disclosed methods should be considered from an illustrative perspective rather than a restrictive one. The scope of the present invention is defined not by the foregoing description but by the appended claims, and all differences within the scope of the claims shall be interpreted as falling within the scope of the present invention.

1. A power transmission device, comprising:
a PV module connection unit receiving power input from a PV module;
a power conversion unit configured to convert the power input from the PV module;
a battery connection unit connected to a battery to output power to the battery or receiving power input from the battery;
an inverter connection unit outputting power to the inverter, when connected to an inverter, and connected in parallel to the battery connection unit; and
a control unit configured to control the PV module by communicating with the PV module, and control the battery connection unit and the inverter connection unit to output power converted by the power conversion unit to the battery or the inverter.

2. The power transmission device of claim 1, wherein the control unit performs maximum power point tracking control on the power conversion unit to enable the PV module to output maximum power.

3. The power transmission device of claim 1, comprising:
a power line communication unit configured to communicate with the PV module via a power line electrically connected to the PV module.

4. The power transmission device of claim 1, wherein the PV module comprises an RSD unit configured to reduce a voltage of the PV module to a value below a first value when a fault in the PV module is detected.

5. The power transmission device of claim 1, wherein the PV module comprises a plurality of PV modules, and the plurality of PV modules is connected in series to the PV module connection unit.

6. The power transmission device of claim 1, wherein the PV module comprises a plurality of PV modules, and the plurality of PV modules is connected in parallel to the PV module connection unit.

7. The power transmission device of claim 1, comprising:
a fault detection unit configured to detect fault of the PV module.

8. The power transmission device of claim 1, comprising:
an input current sensing unit configured to measure an input current of the power input to the PV module connection unit;
an input voltage sensing unit configured to measure an input voltage of the power input to the PV module connection unit;
a power conversion unit output current sensing unit configured to measure an output current of the power output from the power conversion unit;
a power conversion unit output voltage sensing unit configured to measure an output voltage of the power output from the power conversion unit; and
an output current sensing unit configured to measure an output current of the power output to the inverter connection unit.

9. The power transmission device of claim 1, comprising:
a first switching unit connected to or disconnected from the battery; and
an initial charging unit configured to perform initial charging when connected to the battery.

10. The power transmission device of claim 1, comprising:
a communication unit configured to communicate with a battery management device that manages the battery.

11. The power transmission device of claim 1, comprising:
a second switching unit connecting or disconnecting the inverter; and
a bypass unit forming a bypass path over the inverter connection unit.

12. The power transmission device of claim 11, wherein the bypass unit forms the bypass path over the inverter connection unit when a connection to the inverter connection unit is disconnected in accordance to operating of the second switching unit.

13. The power transmission device of claim 1, wherein the power conversion unit comprises one of a buck converter, a boost converter, and a buck-boost converter.

14. A power transmission device, comprising:
a PV module connection unit connected to the output of the PV module;
a power line communication unit connected to a (+) power line of the PV module connection unit to perform communication with the PV module;
a fault detection unit connected to a (−) power line of the PV module connection unit to detect fault in the PV module;
an input current sensing unit configured to measure a current in the (+) power line of the PV module connection unit;
an input voltage sensing unit configured to measure a voltage of the (+) power line of the PV module connection;
a power conversion unit configured to convert a power input from the PV module;
a first diode connected to the power line of the PV module connection unit to block current to the PV module;
a battery connection unit connected to a battery to output power to the battery or receive power input from the battery;
an inverter connection unit connected in parallel with the battery connection unit, outputting power to the inverter when connected to an inverter;
a power conversion unit output current sensing unit configured to measure an output current of the power output from the power conversion unit;
a power conversion unit output voltage sensing unit configured to measure an output voltage of the power output from the power conversion unit;
a first switching unit connected to a power line of the battery connection unit to connect or disconnect the battery;
an output current sensing unit configured to measure a current in the (+) power line of the inverter connection unit;
a second switching unit connected to a (−) power line of the inverter connection unit to connect or disconnect the inverter; and
a bypass unit connected to both the (+) and (−) power lines of the inverter connection unit to form a bypass path.

15. The power transmission device of claim 14, wherein the power conversion unit performs maximum power point tracking control for the PV module.

16. The power transmission device of claim 14, wherein the power conversion unit comprises one of a buck converter, a boost converter, and a buck-boost converter.

17. The power transmission device of claim 14, wherein the power conversion unit comprises a first capacitor connecting a front end power line and (−) power line of the inverter connection unit.

18. The power transmission device of claim 14, wherein the PV module comprises an RSD unit configured to reduce a voltage of the PV module to a value below a first value when a fault in the PV module is detected.

19. The power transmission device of claim 14, wherein the PV module comprises a plurality of PV modules, and the plurality of PV modules is connected in series to the PV module connection unit.

20. The power transmission device of claim 14, wherein the PV module comprises a plurality of PV modules, and the plurality of PV modules is connected in parallel to the PV module connection unit.
